(19) United States
(12) Patent Application Publication
(10) Pub. No.: US 2003/0112944 A1
(43) Pub. Date: Jun. 19, 2003

(54) Identifying relevant scheduling events for a call

(75) Inventors: Michael Wayne Brown, Georgetown, TX (US); Joseph Herbert McIntyre, Austin, TX (US); Michael A. Paolini, Austin, TX (US); James Mark Weaver, Austin, TX (US); Scott Lee Winters, Austin, TX (US)

Correspondence Address: BIGGERS & OHANIAN PLLC, 5 SCARLETT RIDGE, AUSTIN, TX, 78737, US

(73) Assignee: INTERNATIONAL BUSINESS MACHINES CORPORATION, ARMONK, NY

(21) Appl. No.: 10/022,161

(22) Filed: Dec. 17, 2001

(51) Int. Cl. H04M 3/42

(52) U.S. Cl. 379/201.01; 379/210.01

(57) ABSTRACT

A method, system, and program for identifying relevant scheduling events for a call. When a call is received at a service provider, the service provider initiates a call context request. A context inference service handling the call context request accesses a schedule of at least one party to the call. Then, the services designates a context for the call indicating at least one scheduled event from the schedule that is relevant to the call. A schedule may be accessed from a telephony device, a data storage system within a trusted telephone network, or a data storage system accessible via a network outside a trusted telephone network.

### BACKGROUND OF THE INVENTION

1. Technical Field

The present invention relates in general to telecommunications and, in particular, to voice identification. Still more particularly, the present invention relates to identifying relevant scheduling events for a call.

2. Description of the Related Art

Telephone service has created communication channels worldwide, and those channels continue to expand with the advent of cellular and other wireless services. A person can simply take a telephone off-hook and dial a destination number or press a send button and be connected to a telephone line around the world.

Today, the public switching telephone network (PSTN), wireless networks, and private networks telephone services are based on the identification of the wireless telephone or wireline that a calling party uses. A service, often referred to as Acaller IDA, provides the party receiving a call with the line number and name of the subscriber of the line number originating the call.

One limitation of caller ID is that the identity of the party actually making the call is not received, just the name of the line subscriber. For example, in a private network, if AJoe Smith@is making a call from ATom Arnold's office line@only the extension for ATom Arnold's office line@and an identifier for ATom Arnold@ are transferred to the called party.

Another limitation of caller ID is that the identity of the party answering the call is not returned to the party making the call. For example, in a PSTN, a single line number may be answered by multiple parties, and at multiple telephone devices.

A further limitation of caller ID is that a line number and line subscriber name provide a limited context for a call. For example, in a wireless network, where ATom Jenkins@calls a friend's wireless number, ATom Jenkins@does not receive any information about whether the call is wireless, how the call is being billed, and whether the wireless number is a business or personal number.

Further, currently, call context is limited in that it is not linked to a schedule for the caller or callee. While scheduling software may allow employees to view one another's schedules within the scheduling software interface. Where a callee answers a call while in a meeting, the caller is not alerted to such a scheduled event.

Therefore, in view of the foregoing, it would be advantageous to provide a method, system, and program for providing the context of a call. In particular, it would be advantageous to indicate in the context of a call scheduled events associated with the caller or callee that are relevant to the call.

### SUMMARY OF THE INVENTION

In view of the foregoing, it is therefore an object of the present invention to provide an improved telecommunications system.

It is another object of the present invention to provide a method, system and program for improved voice identification.

It is yet another object of the present invention to provide a method, system and program for identifying whether a call is made or receive on behalf of another.

According to one aspect of the present invention, a context service detecting a context request for a call. A schedule of at least one party to the call is accessed. Then, a context for the call is designated indicating at least one scheduled event from the schedule relevant to the call.

According to another aspect of the present invention, a call context is detected for a particular call at a telephony device utilized to participate in the call, wherein the call context indicates at least one scheduled event relevant to the call. Output of the at least one schedule event from at least one output interface of the telephony device is controlled.

According to yet another aspect of the present invention, a current scheduled event selection for a party is detected at a telephony device. Responsive to detecting a call initiated at the telephony device, the current scheduled event selection is transferred as context for the call.

All objects, features, and advantages of the present invention will become apparent in the following detailed written description.

### BRIEF DESCRIPTION OF THE DRAWINGS

The novel features believed characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings, wherein:

FIG. 1 depicts a block diagram of a network environment in which the present invention may be implemented;

FIG. 2 illustrates a block diagram of an identity authentication and context inference system in accordance with the method, system, and program of the present invention;

FIG. 3 depicts a block diagram of the flow of a call through a context inference system in accordance with the method, system, and program of the present invention;

FIG. 4 illustrates an illustrative example of context for a call in accordance with the method, system, and program of the present invention;

FIG. 5 depicts an illustrative embodiment of enhanced context for a call in accordance with the method, system, and program of the present invention;

FIGS. 6a-6b illustrate a block diagram of a personal scheduling interface, in accordance with the method, system, and program of the present invention; and

FIG. 7 depicts a high level logic flowchart of a process and program for controlling call context in accordance with the method, system, and program of the present invention.

### DETAILED DESCRIPTION OF THE PREFERRED EMBODIMENT

A method, system, and program for identifying a scheduled event relevant to a call are provided. The context of a call may include, but is not limited to, the identity of the caller or callee, the identity of devices utilized for the call, the location of the devices utilized for the call, and a billing plan for the call. In particular, in the present invention, the location of a caller or callee, subject matter of the call, and other event information may be inferred from a scheduled event accessed for the caller or callee that is relevant to the time period of the call.

In particular, determining relevant scheduled events and inferring location and subject matter of a call may be performed by a context inference engine located within an Intelligent Peripheral of the trusted telephone network and/or located within a Telco Application service outside the trusted telephone network. As will be further described, the Telco application service located outside the trusted telephone network is enabled to provide services to callers and callees via enhanced security channels.

For personal use, providing scheduled event context is particularly advantageous to facilitate consideration of others time. It is advantageous for enhancing communications between friends and between business colleagues to provide textual indicators to one another of what the parties to the call are doing other than talking on the phone.

The identity of the caller and callee are preferably authenticated. In particular, identity authentication is preferably performed by authenticating the voices of the caller and callee, however other biometric input may also be utilized for identification. Identity authentication may be initiated by the origin device originating the call, the intermediary device processing the call, or the destination device receiving the call. Each of the devices may also access a third party or external server to perform the identity authentication. Performance of identity authentication has different advantages depending on the device initiating and performing the identity authentication.

While in the present invention, authentication of a caller or callee identity is described with emphasis placed on voice authentication, other methods of caller and callee identity authentication may also be performed. Voice samples utilized for voice authentication are just one of multiple types of biometric sampling. For example, a caller or callee may locally provide an eye scan, a fingerprint, and other biophysical identifiers that are transmitted within or outside the trusted network to authenticate the identity of the caller or callee. Alternatively, keypad entries, such as a pin code, account number, password, or other secure transaction key may be entered by a caller or callee and utilized to authenticate the identity of the caller or callee.

For purposes of the present invention, telephony devices are termed origin devices when utilized for origination of a call to an intermediary device and are termed destination devices when utilized for receipt of a call from an intermediary device. Subscribers to a call are termed callers when originating a call and are termed callees when receiving a call. Callers and callees may or may not be line subscribers to the particular telephony device utilized.

In addition, for purposes of the present invention, a caller and a callee are parties to a call. However, a caller or callee may place a call on behalf of another party, where that party is effectively a party to the call. In addition, multiple people may participate in a call, such as a conference call or three-way calling.

In the following description, for the purposes of explanation, numerous specific details are set forth to provide a thorough understanding of the present invention. It will be apparent, however, to one skilled in the art that the present invention may be practiced without these specific details. In other instances, well-known structures and devices are shown in block diagram form to avoid unnecessarily obscuring the present invention.

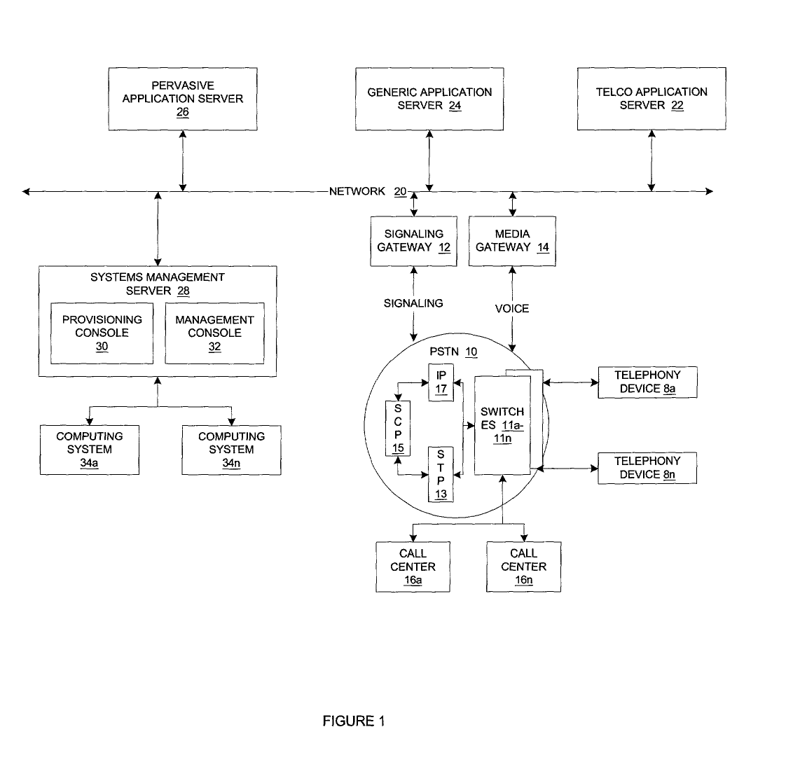

With reference now to the figures, and, in particular, with reference now to FIG. 1, there is depicted a block diagram of a network environment in which the present invention may be implemented. While the present invention is described with reference to one type of network environment, it will be understood by one with skill in the art that the present invention may be implemented in alternate types of network environments.

First, the network environment incorporates a Public Switching Telephone Network (PSTN) 10. As is known in the art the core of PSTN 10 may include multiple telephone networks, each owned by one of multiple independent service providers. Each telephone line is carried by an independent service provider within PSTN 10 and is typically assigned to at least one subscriber.

Switching of a call within an independent service provider's telephone network is considered trusted movement within a trusted network because the call remains within the company's telephone network infrastructure. However, calls may be transferred from one service provider's telephone network to another service provider's telephone network in generally trusted movement. Generally, service providers are in competition with one another and therefore there is general trust in transferring a call, but not trust in sharing of subscriber information beyond a subscriber number and name from one service provider to the next without security features or other arrangements.

Advantageously, each telephone network within PSTN 10 may access a data network functioning as an extension to PSTN 10 via an Intranet. Data networks may include, for example, subscriber profiles, billing information, and preferences that are utilized by a service provider to specialize services. Transfer of information between a service provider's data network and telephone network is trusted movement in sharing of information.

Further, each telephone network within PSTN 10 may access server systems external to PSTN 10 in the Internet Protocol over the Internet or an Intranet. Such external server systems may include an enterprise server, an Internet service provider (ISP), an access service provider (ASP), a personal computer, and other computing systems that are accessible via a network. In the present embodiment, transfer of information between PSTN 10 and server systems accessible via a network 20 is untrusted and therefore may require verification and additional security. Network 20 may be preferably considered an external network.

In the present invention, network 20 may comprise a private network, an Intranet, or a public Internet Protocol network. Specifically, telco application server 22, generic application server 24, pervasive application server 26, and systems management server 28 represent server systems external to PSTN 10 that may be accessed by PSTN 10 over network 20.

In particular, telco application server 22 preferably includes multiple telco specific service applications for providing services to calls transferred to a server external to PSTN 10. In particular, a call may be transferred from PSTN 10 to telco application server 22 to receive at least one service and then the call is transferred back to PSTN 10. PSTN 10 preferably brokers the connection between the telephony device and telco application server 22. Such services may also be provided to calls within PSTN 10, however placing such services at a third party such as telco application server 22, is advantageous because adding services and information to PSTN 10 is time consuming and costly when compared with the time and cost of adding the services through telco application server 22.

In accord with an advantage of the present invention, as will be further described, the identity of both the caller and the callee may be authenticated by one of telephony devices 8a-8n, PSTN 10, or by telco application server 22. By authenticating the actual identity of the person making a phone call and the person receiving the phone call, rather than the identification of a device from which a call is made and received, an enhanced specialization of services to subscribers may be performed.

An authentication service within telco application server 22 may include identification and verification of the identity of a caller and/or callee of a particular call. Such a service may require that subscribers provide voice samples when setting up a subscription. The stored voice samples may then be compared against voice samples received for a particular call in order to authenticate the identity of a current caller or callee of the particular call.

Generic application server 24 preferably accesses independent server systems that provide services. For example, a messaging server, a financial server, an Internal Revenue Service (IRS) server, and database management system (DBMS) server may be accessed in HTTP via network 20. Each of these servers may include a telco service application that requires authentication of the subscriber before access is granted. For example, a financial server may provide a telco service application that allows an authenticated subscriber to access current financial records and request stock quotes from the financial server.

Pervasive application server 26 manages services for wirelessly networked devices. In particular, pervasive application server 26 preferably handles distribution of wireless packets of voice and data to wirelessly networked devices utilizing a standard such as short messaging service (SMS) messaging or other 3G standards.

Systems management server 28 manages subscriber personalization via the web. In particular, systems management server 28 includes browser technology that includes a provisioning console 30 for establishing a subscriber profile and a management console 32 for managing and updating the subscriber profile. A subscriber preferably accesses the consoles of systems management server 28 via the Internet utilizing a computing system, such as computing systems 34a-34n.

The subscriber profile may be accessed at systems management server 28 by other external servers and PSTN 10 via network 20. In addition, a local copy of a subscriber profile updated in systems management server 28 may be stored within a particular service provider's data network or telephone network. Each service provider may specify the types of preferences and other information included within a subscriber profile.

In particular, a subscriber may provide a voice imprint when establishing a subscriber profile through provisioning console 30. Other types of authentication information may also be provided including, but not limited to, a password, an eye scan, a smart card ID, and other security devices. In addition, a subscriber may designate billing preferences, shopping preferences, buddy list preferences, and other preferences that enable specialized service to the subscriber when the subscriber's identity is authenticated from the voice imprint or other identification.

Advantageously, a management agent is built into each external server to monitor the services provided by each server according to the authenticated subscriber receiving the services. By monitoring service output according to subscriber, the subscriber may then be billed according to each use of a service.

PSTN 10 preferably includes both voice and data signaling networks that interface with network 20 via gateways. Each of the gateways acts as a switch between PSTN 10 and network 20 that may compress a signal, convert the signal into Internet Protocol (other protocol) packets, and route the packets through network 20 to the appropriate server.

In particular, the voice network interfaces with network 20 through media gateway 14 which supports multiple protocol gateways including, but not limited to, SIP. SIP is a signaling protocol for Internet conferencing, telephony, presence, events notification and instant messaging.

In addition, in particular, the data signaling network interfaces with network 20 through signaling gateway 12 which supports multiple protocol gateways including, but not limited to, parlay protocol gateways and SS7 protocol gateways. Internet servers, such as telco application server 22 may include protocol agents that are enabled to interact with multiple protocols encapsulated in Internet Protocol packets including, but not limited to, SS7 protocol, parlay protocol, and SIP.

Looking into PSTN 10, a telephone network typically includes multiple switches, such as central office switches 11a-11n, that originate, terminate, or tandem calls. Central office switches 11a-11n utilize voice trunks for transferring voice communications and signaling links for transferring signals between signaling points.

Between signaling points, one central office switch sends signaling messages to other central office switches via signaling links to setup, manage, and release voice circuits required to complete a call. In addition, between signaling points, central office switches 11a-11n query service control points (SCPs) 15 to determine how to route a call. SCPs 15 send a response to the originating central office switch containing the routing number(s) associated with the dialed number.

SCPs 15 may be general purpose computers storing databases of call processing information. While in the present embodiment SCPs 15 are depicted locally wit in PSTN 10, in alternate embodiments SCPs 15 may be part of an extended network accessible to PSTN 10 via a network.

One of the functions performed by SCPs 15 is processing calls to and from various subscribers. For example, an SCP may store a record of the services purchased by a subscriber, such as a privacy service. When a call is made to the subscriber, the SCP provides record of the privacy service to initiate an announcement to a caller to identify themself to the subscriber with the privacy service who is being called. According to an advantage of the invention, authentication of the subscriber receiving the call may be required before the privacy service is initiated for that subscriber.

In particular, network traffic between signaling points may be routed via a packet switch called an service transfer point (STP) 13. STP 13 routes each incoming message to an outgoing signaling link based on routing information. Further, in particular, the signaling network may utilize an SS7 network implementing SS7 protocol.

Central office switches 11a-11n may also send voice and signaling messages to intelligent peripherals (IP) 17 via voice trunks and signaling channels. IP 17 provides enhanced announcements, enhanced digit collection, and enhanced speech recognition capabilities.

According to an advantage of the present invention, the identity of a caller is authenticated according to voice authentication. Voice authentication is preferably performed by first identifying a subscriber by matching the name or other identifier spoken with a subscriber name or identifier. Next, voice authentication requires verifying that the voice audio signal matches that of the identified subscriber. However, in alternate embodiments, the identity of a caller may be authenticated according to passwords, eye scans, encryption, and other security devices.

In particular, to perform subscriber authentication of audio signals received from callers, IP 17 may include storage for subscriber specific templates or voice feature information, for use in authenticating subscribers based on speech. If a subscriber specific template is not stored on a local IP 17, then a remote IP containing the subscriber specific template may be accessed via a network. In addition, local IP 17 may access systems management server 28 or another repository for voice imprints to access the subscriber specific template.

Where IP 17 authenticates the identity of a caller (e.g. the subscriber placing a call), a voice identifier (VID) representing the authenticated caller identity is transferred as a signal for identifying the caller. In addition, where IP 17 authenticates the identity of a callee (e.g. the subscriber receiving a call), a reverse VID (RVID) including the callee identity is transferred as a signal for identifying the callee.

Alternatively, to perform subscriber authentication of audio signals received from callers, PSTN 10 may broker a caller identity authentication service from telco application server 22. In particular, a signaling channel is opened between central office switches 11a-11n and telco application server 22 via signaling gateway 12. In addition, a voice channel is opened between central office switches 11a-11n and telco application server 22 via media gateway 14.

Because telco application server 22 is located outside of the trusted network, there may be a time delay associated with establishing a connection to telco application server 22 and authenticating the identity of a caller that is longer than a time delay present where a caller identity is authenticated by IP 17.

In addition, because telco application server 22 is located outside of the trusted network, it is advantageous to establish a level of security for transactions between telco application server 22 and central office switches 11a-11n, wherein the level of security is suitable for untrusted communications. A level of security may be implemented by utilizing security based protocols, such as the secure socket layer, and by applying ordinary encryption. In particular, the level of security preferably protects the communication channel between telco application server and PSTN 10 and authenticates the identity of the server from which a caller identity authentication service is accessed. Therefore an additional feature of signaling gateway 12 and media gateway 14 is security verification.

Advantageously, VIDs indicate through text, voice, or video the identity of a caller. For example, a caller's name may be transferred as the identity of a caller. Alternatively, a video clip stored with the subscriber template may be transferred as the identity of a caller. Additionally, VIDs may indicate the identity of the device utilized by a caller to provide context for a call. Further, VIDs may indicate which system or systems have authenticated the caller identity.

After a VID and/or RVID are determined by IP 17, IP 17 and SCP 15 may communicate to designate which services are available according to VID and RVID. Advantageously, by designating services according to a VID and/or RVID, subscribers are provided with services and billed for those services independent of the devices utilized by subscribers. In particular, a 1129 protocol or other protocol may be utilized to enable signal communications between IP 17 and SCPs 15.

In addition, as previously described, caller authentication to determine VIDs and RVIDs may be performed by an external system, such as telco application server 22. The VID or RVID returned from telco application server 22 may be transferred from central office switches 11a-11n to SCP 15 in order to access a subscriber profile associated with the VID or RVID. Alternatively, the VID or RVID may first transfer to IP 17, where additional verification of the caller identity is performed. For example, IP 17 may control distribution of the VID to the caller, where the caller is prompted to enter a password or additional information. IP 17 may then initiate loading the caller profile into central office switches 11a-11n if the additional caller input is verifiable for the VID.

An origin telephony device or destination telephony device may also determine a VID and/or RVID for the caller and/or callee of a call. In particular, telephony devices 8a-8n and call centers 16a-16n may function as origin and destination telephony devices. Each of the telephony devices may include a database of voice templates that may be matched to authenticate the identity of a caller or callee. In addition, each of the telephony devices may access a third party, such as telco application server 22, to authenticate the identity of the caller or callee. In either case, the telephony device transmits a VID and/or RVID with a call to PSTN 10.

Telephony devices 8a-8n may include, but are not limited to wireline devices, wireless devices, pervasive device equipped with telephony features, a network computer, a facsimile, a modem, and other devices enabled for network communication. Advantageously, as previously described, a voice authentication functioning device may be included in each of telephony devices 8a-8n.

In addition, telephony devices 8a-8n may each incorporate a display that provides a visual output of a VID or RVID. Alternatively, such a display may be provided in a separate device connected to the line in parallel to telephones 8a-8n. According to one advantage of the present invention, the identity of the actual caller or actual callee are output to a display in association with a call. In addition, other context information about the caller including, but not limited to, the device from which the call originates or is answered, ratings for a caller or callee, and other context information may be output to a display in association with a call.

Telephony devices 8a-8n are communicatively connected to PSTN 10 via wireline, wireless, ISDN, and other communication links. Preferably, connections to telephony devices 8a-8n provide digital transport for two-way voice grade type telephone communications and a channel transporting signaling data messages in both directions between telephony devices 8a-8n and PSTN 10.

In addition to telephony devices 8a-8n, advanced telephone systems, such as call centers 16a-16n, may be communicatively connected to PSTN 10 via wireline, wireless, ISDN and other communication links. Call centers 16a-16n may include PBX systems, hold queue systems, private network systems, and other systems that are implemented to handle distribution of calls to multiple representatives or agents.

Returning to central office switches 11a-11n, typically, one central office switch exists for each exchange or area served by the NXX digits of an NXX-XXXX (seven digit) telephone number or the three digits following the area code digits (NPA) in a ten-digit telephone number. The service provider owning a central office switch also assigns a telephone number to each line connected to each of central office switches 11a-11n. The assigned telephone number includes the area code (NPA) and exchange code (NXX) for the serving central office and four unique digits (XXXX).

Central office switches 11a-11n utilize office equipment (OE) numbers to identify specific equipment, such as physical links or circuit connections. For example, a subscriber's line might terminate on a pair of terminals on the main distribution frame of one of central office switches 11a-11n. The switch identifies the terminals, and therefore a particular line, by an OE number assigned to that terminal pair. For a variety of reasons, a service provider may assign different telephone numbers to the one line at the same or different times. For example, a local carrier may change the telephone number because a subscriber sells a house and a new subscriber moves in and receives a new number. However, the OE number for the terminals and thus the line itself remains the same.

On a normal call, a central office switch will detect an off-hook condition on a line and provide a dial tone. The switch identifies the line by the OE number. The central office switch retrieves profile information corresponding to the OE number and off-hook line. Then, the central office switch receives the dialed digits from the off-hook line terminal and routes the call. The central office switch may route the call over trunks and possibly through one or more central office switches to the central office switch that serves the called party's station or line. The switch terminating a call to a destination will also utilize profile information relating to the destination, for example to forward the call if appropriate, to apply distinctive ringing, etc.

In the present invention, authentication of the identity of the caller is preferably initiated in IP 17 or telco application server 22. Once a VID for a caller is received at a central office switch, a context inference service is initiated in IP 17 or telco application server 22. The context inference engine preferably requests a caller profile according to VID to retrieve scheduling, billing, and other personal information about the caller. In addition, the context inference engine preferably determines the identity of the device utilized by accessing a device directory, prompting the caller to indicate the device identity, or other methods. Further, the location of the device may be inferred from information provided by the central office switch originating the call and relevant scheduled events. A subject matter of the call may be inferred from retrieved information and, in particular, from scheduled events. The context information is preferably filtered by the context inference engine and transferred to the central office switch.

A filtering service may perform additional filtering on context information according to caller preferences or central office preferences. Filtered context information is then transferred with the call routed by one or more central office switches to a destination central office switch that services the called party's station or line.

Then, the context information is forwarded with a caller VID to the callee telephony device. The callee is enabled to determine whether to answer a call, transfer the call to voice mail, or select from other options, based on knowing the identity of the caller and the context, including any relevant scheduled events. For example, if the callee does not want to speak with the caller while the caller is around a particular party also at the scheduled event, then the callee may select to transfer the caller to voice mail.

In addition, authentication of the identity of a callee answering the call is preferably initiated in IP 17 or telco application server 22. Once a RVID for a callee is received at a central office switch, a context inference application is initiated in IP 17 or telco application server 22 to further determine context for the call. According to the present invention, determining the context preferably includes determining any relevant scheduled events for the callee and inferring location, subject matter, and other event information from the relevant scheduled events. The callee context information is preferably filtered according to callee preferences and transferred to the caller, such that the caller is enabled to determine whether the callee is the intended recipient.

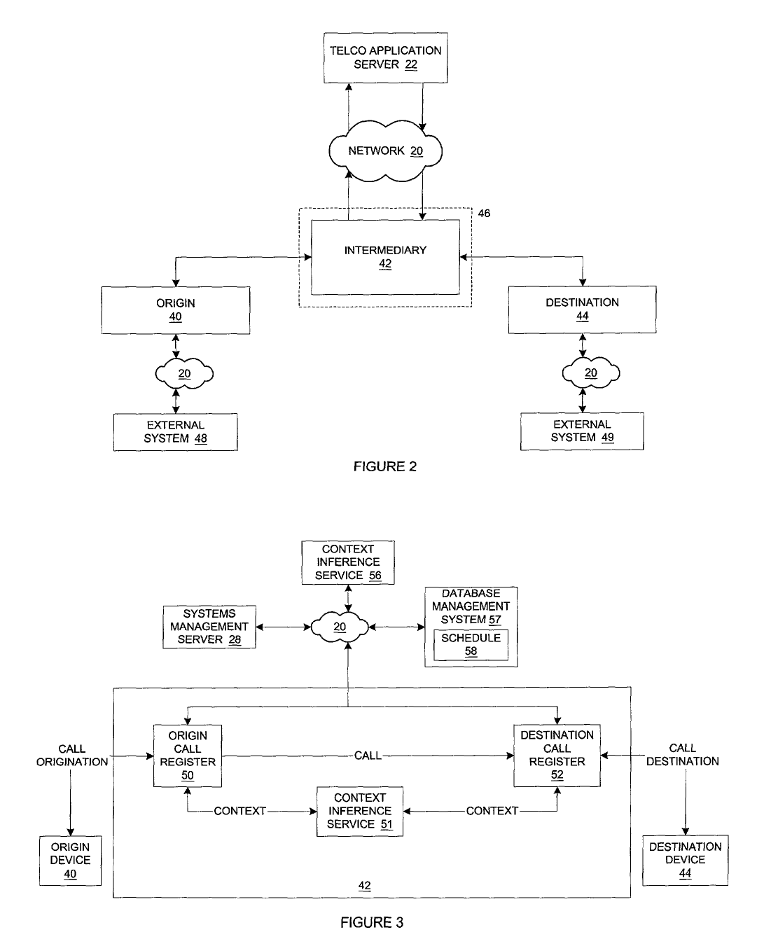

Referring now to FIG. 2, there is illustrated a block diagram of an identity authentication and context inference system in accordance with the method, system, and program of the present invention.

Origin device 40 is utilized by a caller to initiate a call. The caller is prompted by the device performing caller authentication to provide a voice utterance. A VID for the caller is provided to intermediary device 42 from the device performing caller authentication. The VID is utilized to access a caller profile that includes preferences, billing information, and personal information. In addition, the VID is transmitted with the call to destination device 44 for identifying the caller.

In general, caller identity authentication is performed by receiving a voice utterance from a caller, analyzing the voice utterance for sound qualities and content, and attempting to match the sound qualities and content of a voice utterance to a voice template previously recorded for a caller, to authenticate the identity of the caller. If there is a match between the voice utterance and a voice template, then a VID is determined for the caller and utilized to authenticate the caller identity for retrieving a caller profile and billing the caller. However, in alternate embodiments, the identity of a caller may be authenticated according to passwords, eye scans, encryption, and other biometric methods.

Caller identity authentication may be initiated by origin device 40. In particular, origin device 40 may include voice templates and a feature for performing the caller identity authentication. In addition, origin device 40 may access a third party server 48 via network 20, where third party server 48 may provide access to a database of voice templates and/or perform the caller identity authentication. Origin device 40 then transmits a VID determined for the caller to intermediary device 42 for use in specifying services, selecting billing, and determining context for a call from origin device 40. Origin device 40 may include a caller telephony device, a PBX, a call center, a private switching system, network servers, feature servers, and other systems which provide call origination. Third party server 48 may include a telco application server, a generic application server, a database management system server, and other systems that function outside trusted telephone network 46. In particular, intermediary device 42 may facilitate communication between origin device 40 and network 20.

In addition, caller identity authentication may be initiated by intermediary device 42. Intermediary device 42 may include database systems that store voice templates and an IP for performing caller identity authentication. In addition, intermediary device 42 may access telco application server 22 outside of trusted telephone network 46 via network 20, where telco application server 22 provides a caller authentication service and/or provides access to a database of voice templates. Intermediary device 42 may include a PSTN switching network or networks. However, intermediary device 42 may also include a PBX, a call center, or other private switching system. Further, intermediary device 42 may include network servers, Websphere® (Websphere® is a registered trademark of International Business Machines Corporation) servers, and other systems which provide call processing.

Further, caller identity authentication may be initiated by destination device 44. Destination device 44 may include voice templates and a feature for performing the caller identity authentication. In addition, destination device 44 may access a third party server 49 via network 20, where third party server 49 may provide access to a database of voice templates and/or perform the caller identity authentication. Destination device 44 will prompt a caller to provide a voice utterance at origin device 40, where intermediary device 42 facilitates communications between origin device 40 and destination device 44. Destination device 44 then determines and transmits a VID for the caller to intermediary device 42 for use in specifying services, selecting billing, and determining context for a call from origin device 40. Destination device 44 may include a callee telephony device, a PBX, a call center, a private switching system, network servers, feature servers, and other systems which provide call receipt. Third party server 48 may include a telco application server, a generic application server, a database management system server, and other systems that function outside trusted telephone network 46. In particular, intermediary device 42 may also facilitate communication between destination device 44 and network 20.

Similarly, a destination device 44 is utilized by a callee to receive a call. Advantageously, an authenticated identity of the callee may be determined as an RVID. Callee identity authentication may be initiated by origin device 40, intermediary device 42, or destination device 44, in a manner similar to initiation of caller identity authentication, as described above.

In addition to authenticating the identity of a caller or callee in a VID or RVID, the context of the call is preferably determined and transmitted as part of the VID or RVID or separate therefrom. Origin device 40, intermediary device 42, telco application server 22, and/or destination device 44 may include context inference engines that perform context inference services. A context inference engine may utilize context information gathered from multiple databases and may gathered context information directly from a caller or callee in response to prompts. In the present invention, portions or all of a caller profile and other context information may be accessible according to VID or RVID from origin device 40, intermediary device 42, destination device 44, or a database system accessible outside network 46.

Context may include, but is not limited to, a subject matter of a call, a device identity, the location of an origin or destination device, billing information, service subscriptions, the path of line numbers accessed during a call, scheduling and other information which may provide a caller or callee with the context of a call. Information for determining the context of a call may be gathered from a caller or callee profile, from a device directory, from systems management server 28, or other databases of information.

According to an advantage of the present invention, a context inference engine determines relevant scheduled events for a caller or callee from schedules retrieved according to VID or RVID. The relevant scheduled events may include past event, current events, and future events. Past events may be relevant where a past event includes a previous call between the caller and the callee, and the subject matter thereof. Current events may be relevant to indicate a caller or callee location, the current event that a caller or callee is participating in, which other parties are accessible at the event, and the duration of the event. Future events may be relevant where the caller and callee are scheduled for the same future event, where the future event indicates a time that the caller or callee is available to talk, or other indicators.

A VID or RVID may be transferred in multiple protocols, including, but not limited to, Interface Definition Language (IDL). A VID or RVID may include a range of information, where each type of information may be tagged or identified in some other manner. For example, the following tagged VID may be transmitted to represent an authenticated identity of a caller and context of the call:

[name] Jon Smith

[device] Jane Doe's cell phone

[current scheduled event] Project A meeting

[location] Central Time zone, Austin, Tex., meeting room #25

[subject] Project A

[billing] Jon Smith's business service provider

[authenticated by] Jane Doe's cell phone, service provider G

With reference now to FIG. 3, there is depicted a block diagram of the flow of a call through a context inference system in accordance with the method, system, and program of the present invention. As illustrated, origin device 40 transfers a call request to intermediary device 42. The call request may be an off-hook condition for a wireline device or a network service connection request for a wireless device.

Preferably, a switching service receiving the call request establishes an origin call register 50 and retrieves a line subscriber profile for the origin device line number. The line subscriber profile may be accessible from an SCP, a data storage system external to trusted telephone network 46, or origin device 40. In addition, the identity of the caller at origin device 40 may be authenticated in a VID and a caller profile accessed according to the VID from an SCP, a data storage system external to trusted telephone network 46, or origin device 40.

The call is preferably transferred through a voice channel to a destination switch, in which a destination call register 52 is created to hold the call. In addition, profile and other information for the call may be transferred through a signaling channel from origin call register 50 to the destination switch and loaded into destination call register 52. The destination switch then controls termination of the call at destination device 44. In addition, the identity of the callee may be authenticated in an RVID and loaded into destination call register 52.

A context inference service may be initiated by the origin switching system or the destination switching system. In particular, a context inference service 51 may be located within trusted telephone network 46 within an IP. Alternatively, a context inference service 51 may be located outside trusted telephone network 46 within a telco application server accessible via network 20.

The context inference service preferably determines the context for a call including, but not limited to, the identities of parties to a call, the identities of devices utilized in a call, the locations of those devices, the billing plan for a call, services subscribed to and provided by parties to a call, and the subject matter of a call.

To determine the identity of the device utilized to place a call, the entity subscribing to the line number and/or an identifier for the device are preferably accessed. The first set of context clues is provided to the context inference service by the line subscriber profile. In particular, a line subscriber profile indicates the individual or business that subscribes to a particular line number. Further, a line subscriber profile may indicate that a business subscribes to a telephone service, but provide that service is subscribed to for use by a particular employee or group of employees. Alternatively, the line subscriber profile may indicate that the line is a personal line.

Preferably the identity of the device may be inferred from the line subscriber profile and other information available. A device identity may include a device name, a line number utilized to access the device, and the device type. The device name may be assigned by the line subscriber and output with a signal from the device. Alternatively, the line subscriber profile may indicate the device name. The device type may indicate the type of line utilized to access the device, including, but not limited to, wireline, wireless, or multiplexed. In addition, the device type may indicate the type of device accessed by the line including, but not limited to, a car telephone line, a computer modem line, a PBX land line, a residential line, a business line, or an Asymmetric Digital Subscriber Line (ADSL) multiplexed line.

In addition, the line subscriber profile indicates the billing information and services subscribed to by the line subscriber. Billing information may provide context for whether the line number is a business line or personal line. In addition, a billing context for a call may indicate the party responsible for charges incurred in the call.

Further, a line subscriber profile preferably indicates whether the line number is subscribed to for a wireline device, a wireless device, or both. Additional context information may be inferred from whether a wireline or wireless device is utilized.

Further, determining or inferring the location of a device is advantageous context information. For a wireless device, the location of a device may be determined most precisely where a GPS tracking system is utilized by the origin device 40 or intermediary device 42, to determine the exact geographical location of a caller. For a wireline device, the location of the device is fixed according to the location the service is registered for the number.

In addition, for both a wireline and wireless device, a general location of the originated call may be determined from the geographical area covered by the switching center receiving the call. Wireless devices are preferably provided service by a particular tower or other signal distribution point. The geographical location and area covered by that tower may provide a general location of the origin of a call. As the origin device moves from one wireless coverage area to another, the location may be updated.

The context inference service may infer additional context from location information. For example, the time zone of the caller, the direction of movement of the caller, and other location related information may be inferred from location information.

In addition to extending a dial tone to a caller, an identity of the caller is preferably authenticated and loaded into origin call register 50. A caller profile accessed according to the VID is then accessed and loaded into origin call register 50. The context inference service preferably utilizes the caller profile and VID as additional context clues for the call.

In particular, in retrieving a caller profile according to VID, systems management server 28 may be accessed. Systems management server 28 preferably provides an interface through which an individual may adjust preferences, select services, and provide other information, which is stored and made accessible according to the individual's VID. Systems management server 28 may track services that an individual subscribes to, such as a stock subscription service. In addition, systems management server 28 allows an individual to adjust billing information and view current charges according to VID.

The VID provides the context of who is placing the call. The caller profile provides further context based on the billing information and service subscriptions of the caller. In addition to indicating who is answering the call, the role of the person answering the call may be indicated.

In addition, a caller profile may include preferences for filtering context information depending on multiple factors. Such factors may include, but are not limited to, the callee, the device placing the call, the device receiving the call, the time of day, a caller's schedule, and other variables selected by the caller.

The subject matter of a call may be determined by prompting a caller to provide a voice or text entry indicating the subject matter of the call. Alternatively, the context inference engine may infer the subject matter of a call based on the caller's schedule. The context inference engine may also infer the subject matter of a call based on the caller's business or the business associated with the line number utilized by the caller.

The call is preferably transferred through a voice channel to a destination switch, in which a destination call register 52 is created to hold the call. In addition, context for the call may be transferred through a signaling channel to the destination switch and loaded into destination call register 52.

The destination switch preference initiates at least one of context inference service 51 and context inference service 56 to determine the context of the recipient side of a call. Determining the context of the recipient side of a call may be performed in a manner similar to that described with reference to determining the context of the caller side of a call. In addition, as will be further described, context inferences may be further enhanced when caller side and recipient side context information is combined.

The line subscriber profile associated with destination device 44 may be accessed and utilized by the context inference service to determine context for the call. In addition, destination device 44 may return a device identifier to destination call register 52 or the identity of destination device 44 may be inferred from other context information. Further, the identity of the callee is preferably authenticated, such that the RVID and callee profile accessible according to RVID further enhance context information.

Context information determined for the recipient side of the call may be transferred to origin device 40 via origin call register 50. Filtering of the recipient call context may be performed according to multiple factors, including callee filtering preferences. In particular, multiple entities may receive the filtered context information, where filtering preferences may be uniquely specified for each of the multiple entities.

Additional context inferences may be inferred when caller side and recipient side context information is viewed concurrently. For example, where the caller is a subscriber to a stock service and the callee is the stock service, the subject matter of the call may be inferred to include access to the stock service. In another example, where the caller and the callee share the same last name, it may be inferred that there is a relation between the parties. In yet another example, where the caller and the callee share an address or other information, it may be inferred that the parties work at the same business address or live at the same personal address.

According to an advantage of the present invention, the context for a call preferably includes relevant scheduled events and other information inferred from relevant schedule events. Individuals may store schedule information in multiple locations according to a single VID. For example, origin device 40 may include a calendar utilized by a caller for scheduling. In addition, the caller may have a business based calendar accessible via a network server. For example, a database management system 57 managing a schedule 58 is accessible outside trusted telephone network 46. Further, information about a scheduled event may be located on another network server. Moreover, an individual may access a profile via systems management server 28 and control a schedule.

In addition, relevant scheduled events may be retrieved from the schedules of other callers or callees in proximity to a caller or callee to a call. For example, origin device 40 may be equipped with local area networking links, such as Bluetooth networking. Origin device 40 may communicate with the other device is the room to retrieve scheduling and/or identity information of the other individuals associated with devices within the proximity of origin device 40. While the caller associated with origin device 40 may not have the current scheduled event in the caller's calendar, another colleague in the room may have the current scheduled event in the colleague's device schedule or a schedule accessible according to the colleague's identity.

Context information distributed to origin device 40 and/or destination device 44 is preferably output via an output interface. Output interfaces may include, for example, a graphical user interface and an audible output interface. Context information may be further filtered by each device for output. For example, context information may be filtered to utilize only five lines of text.

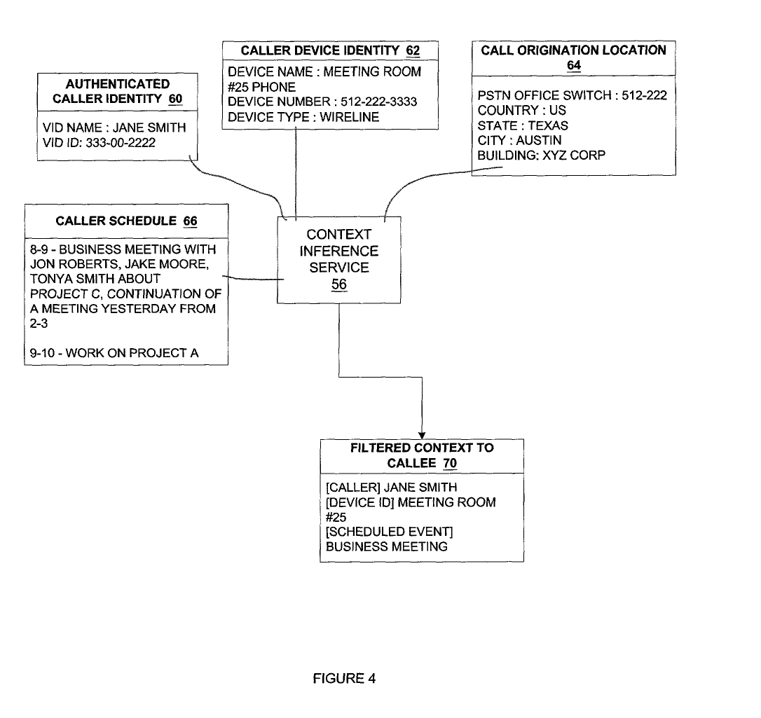

With reference now to FIG. 4, there is depicted an illustrative example of context for a call in accordance with the method, system, and program of the present invention. As illustrated, context inference service 56 receives context related information and outputs filtered context for a call. Context inference service may receive context related information from a switching system requesting context or may search for the context information according to VIDs and RVIDs. In alternate embodiments, alternate types of information may be received at context inference service 56.

An authenticated caller identity context 60 is received including a VID name and a VID ID. While in the present example the caller includes a single individual, in alternate examples, the caller may include multiple individuals, where multiple individuals are utilizing a single line. By authenticating the identity of the caller according to VID, the single identifier may be utilized to access caller profile information from multiple locations accessible via a network.

A caller device identity context 62 is inferred by context inference service from the line number and the line subscriber profile assigned to the line number. The line subscriber profile preferably indicates the type of device assigned to the line number as wireless or wireline and indicates a name assigned to the device. Alternatively, the device itself may output a device name. Further, the device name may be inferred from the line subscriber name. In the example, the device name is preferably assigned in the line subscriber profile according to the room to which the line is configured.

A call origination location context 64 is detected from the geographical area covered by the PSTN office switch originating the call. In addition, the street address or entity to which a line number is assigned may indicate the building or other location from which a call originates. A wireless location may be determined by a detected GPS location of the device.

A caller schedule context 66 is detected from at least one data storage location. Scheduled events may include a date, a time, a location or locations, a type of event, parties scheduled to attend the event, background for the event, and other details that an individual may include in the scheduled event. In the example, caller schedule 66 indicates two scheduled events for the caller. The first event is the scheduled event currently happening. The second event is a future scheduled event.

Context inference service 56 preferably filters the information included in authenticated caller identity context 60, caller device identity context 62, call origination location context 64, and caller schedule context 66 to determine that information relevant to the callee. In this example, the callee is not determined, so the filtered context to the callee 70 is limited to the caller identity, the device identity and the current scheduled event. The filtering may be performed according to preference designated in a caller profile or may be a setting specified for context where a callee is not identified.

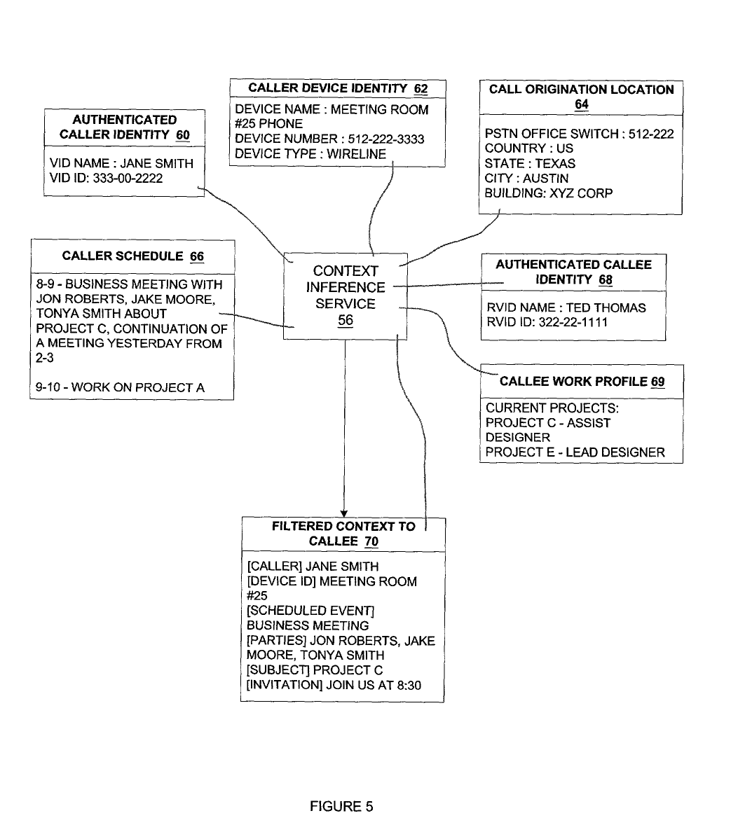

Referring now to FIG. 5, there is illustrated an illustrative embodiment of enhanced context for a call in accordance with the method, system, and program of the present invention. Context accessed and inferred in FIG. 4 is included, in addition to additional context information which allows for enhanced context to the callee.

An authenticated callee identity context 68 indicates the RVID name and RVID ID of the callee. A callee work profile context 69 is preferably accessed from a network accessible database according to the RVID. In the example, callee work profile context 69 indicates the callee's current projects and the role the callee plays in those projects.

Filtered context to callee 70 includes enhanced context information because the callee is part of the project team. Since the callee is part of the project team, the callee is informed not only of the scheduled event, but the parties involved in the event and the subject of the event.

In addition, a caller may select to invite a callee to participate in an event or context inference service 56 may infer that the callee is to be invited to the event. Here, the caller specifies for the callee to be invited to the meeting at 8:30, in addition to placing the call. The invitation to participate in an event may be displayed to the callee, for example, as a hot link to a teleconference or as a time, date and place.

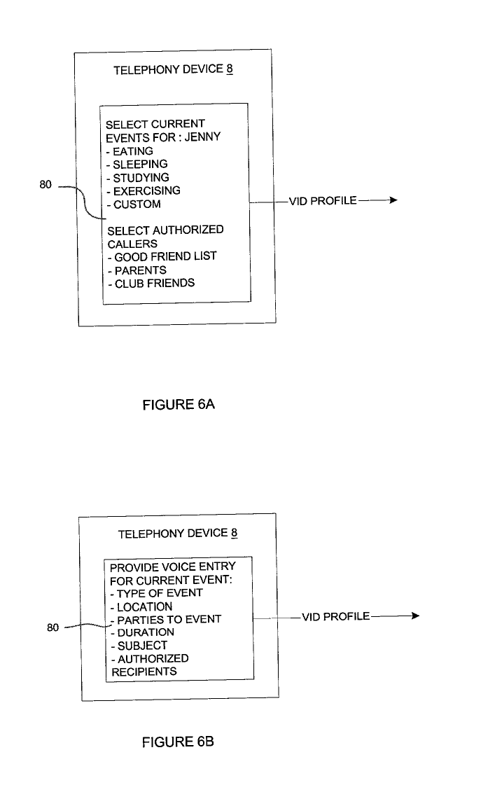

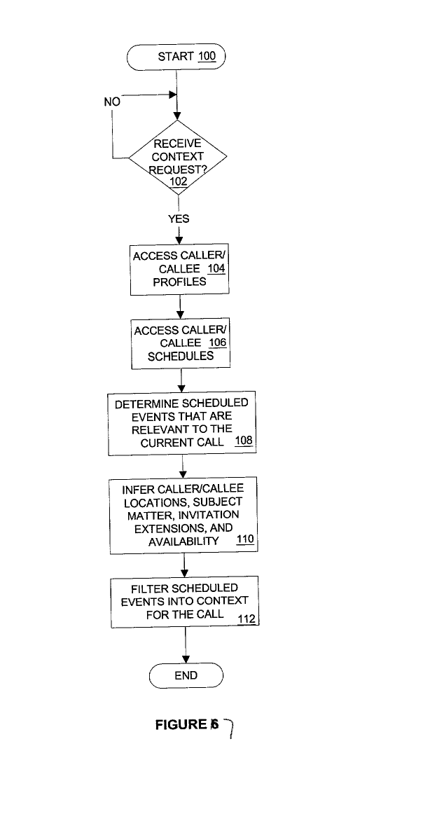

With reference now to FIGS. 6a-6b, there is depicted a block diagram of a personal scheduling interface, in accordance with the method, system, and program of the present invention. Telephony devices, such as telephony device 8, may be equipped with an output interface, such as output interfaces 80 and 82. Individuals are preferably enabled to indicate past, current, and future scheduled events via an output interface. The scheduled events may then be transferred to an intermediary device for storage in a profile according to VID. In addition, the scheduled events may be retrieved from telephony device 8 during a call and transferred according to VID or RVID.

Providing an interface for individuals to enter scheduled events facilitates the process. In particular, individuals may select a current event that is forwarded to a callee when the individual places a call, however that same current event or a filtered version of the current event may be returned to the caller when the individual receives a call.

For personal use, providing scheduled event context is particularly advantageous to facilitate consideration of others time. It is advantageous for enhancing communications between friends and between business colleagues to provide textual indicators to one another of what the parties to the call are doing other than talking on the phone.

In the example, output interface 80 allows an individual to select a current event according to a particular VID and designate those callers authorized to view the scheduled event and information surrounding the scheduled event. The VIDs of callers authorized to view the scheduled event may be selected as groups or as individuals. Here, if Jenny indicates that she is eating, authorized callers attempting to contact Jenny may first request a call context for Jenny. By requesting the call context, the caller is informed that Jenny is eating and the caller may decide to place the call later. In addition, the caller may be informed that Jenny is eating as part of the call context, notifying the caller of the reason Jenny is not answering the phone. Further, if Jenny answers the call, the caller is already informed that Jenny is eating and may keep the conversation short.

In addition, to selecting from a textual list, an individual may be prompted with voice and/or text prompts to enter a scheduled event through voice and/or keypad entry. In the example, output interface 82 provides voice and text prompts to an individual to enter a scheduled event. For example, the individual is prompted to enter a type of event, an event location, parties to the event, a duration, a subject, and authorized recipients of the scheduled event. In addition, an individual may designate certain portions of the scheduled event that some recipients may view and other portions of the scheduled event that other recipients may view. Further, an individual may describe the event in one manner to a particular group of recipients and in another manner to another group of recipients.

Referring now to FIG. 7, there is depicted a high level logic flowchart of a process and program for controlling call context in accordance with the method, system, and program of the present invention. As illustrated, the process starts at block 100 and thereafter proceeds to block 102. Block 102 illustrates a determination as to whether a context request is received. If a context request is not received, then the process iterates at block 102. If a context request is received, then the process passes to block 104.

Block 104 depicts accessing caller/callee profiles according to VID and RVID. Profiles preferably include caller preferences, wherein those caller preferences may rank individual VIDs according to access to profile information. Profiles may also include billing information, service subscriptions, business specific information, and other personalized information accessible across the network according to a single VID identifier.

Next, block 106 illustrates accessing caller/callee schedules. A caller/callee may be prompted to enter a current scheduled event if one is not already entered. In particular, a caller may request, with a call, for the callee to indicate a current event before voice channel between the parties is connected. In addition, caller/callee schedules may be accessed from origin and destination devices, from data storage systems within the trusted telephone network, and from data storage systems accessible outside the trusted telephone network, where schedules are accessible according to a VID or RVID. In particular, when accessing schedules, the request may indicate a particular time period, particular types of events, particular parties involved, particular locations, particular subjects, or other criteria for the scheduled events from an entire schedule that are accessed.

Thereafter, block 108 depicts determining which scheduled events are relevant to the current call. Relevant scheduled events may include, for example, the current scheduled event. However, if a caller and a callee are scheduled for an event together in thirty minutes, that future scheduled event may become relevant.

Next, block 110 illustrates inferring caller/callee locations, subject matter, invitation extensions and availability to talk from the profiles and relevant scheduled events. Thereafter, block 112 depicts filtering the scheduled events into context for the call, and the process ends. Filtering is preferably performed according to the authorization level of a caller/callee to view scheduled events and other context information inferred from a scheduled event.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMS, DVD-ROMS, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

While the invention has been particularly shown and described with reference to a preferred embodiment, it will be understood by those skilled in the art that various changes in form and detail may be made therein without departing from the spirit and scope of the invention.

What is claimed is:

1. A method for determining a call context, comprising:
detecting a context request for a call;
accessing a schedule of at least one party to said call;
designating a context for said call indicating at least one scheduled event from said schedule relevant to said call.

2. The method for determining a call context according to claim 1, further comprising:
authenticating an identity of said at least one party to said call; and
accessing said schedule of said at least one party to said call according to said authenticated identity of said at least one party.

3. The method for determining a call context according to claim 1, wherein accessing said schedule further comprises:
accessing said schedule from at least one data storage location within a trusted telephone network processing said call.

4. The method for determining a call context according to claim 1, wherein accessing said schedule further comprises:
accessing said schedule from at least one data storage location accessible via a network outside a trusted telephone network processing said call.

5. The method for determining a call context according to claim 1, wherein accessing said schedule further comprises:
accessing said schedule from a device utilized to place said call.

6. The method for determining a call context according to claim 1, wherein accessing said schedule further comprises:
accessing said schedule from a device utilized to answer said call.

7. The method for determining a call context according to claim 1, further comprising:
inferring a location of said at least one party to said call from said at least one schedule d event.

8. The method for determining a call context according to claim 7, wherein said location is at least one of a past location, a current location, and a future location.

9. The method for determining a call context according to claim 1, further comprising:
inferring a time said at least one party is available to communicate during said call from said at least one scheduled event.

10. The method for determining a call context according to claim 1, further comprising:
inferring an environment of said at least one party to said call from said at least one scheduled event.

11. The method for determining a call context according to claim 10, wherein said environment comprises a type of scheduled event, attendees of said at least one scheduled event, a subject of said at least one schedule event, and a background of said scheduled event.

12. The method for determining a call context according to claim 1, further comprising:
inferring at least one party in communication with at least one other participant at said at least one scheduled event.

13. The method for determining a call context according to claim 1, further comprising:
filtering said call context according to preferences of said at least one party; and
transferring said filtered call context to a requesting switching system for distribution.

14. The method for determining a call context according to claim 1, further comprising:
inviting at least one party to said call to join said scheduled event.

15. The method for determining a call context according to claim 1, further comprising:
accessing a schedule of a user detected within a particular proximity of said at least one party, wherein said schedule is detected via a local network connection with a device associated with said user.

16. A system for determining a call context, comprising:
a context inference server communicatively connected to a telephone network;
means for receiving a context request for a call at said context inference server;
means for accessing a schedule of at least one party to said call; and
means for designating a context for said call indicating at least one scheduled event from said schedule relevant to said call.

17. The system for determining a call context according to claim 16, further comprising:
means for authenticating an identity of said at least one party to said call; and
means for accessing said schedule of said at least one party to said call according to said authenticated identity of said at least one party.

18. The system for determining a call context according to claim 16, wherein said means for accessing said schedule further comprises:
means for accessing said schedule from at least one data storage location within a trusted telephone network processing said call.

19. The system for determining a call context according to claim 16, wherein said means for accessing said schedule further comprises:
means for accessing said schedule from at least one data storage location accessible via a network outside a trusted telephone network processing said call.

20. The system for determining a call context according to claim 16, wherein said means for accessing said schedule further comprises:
means for accessing said schedule from a device utilized to place said call.

21. The system for determining a call context according to claim 16, wherein said means for accessing said schedule further comprises:
means for accessing said schedule from a device utilized to answer said call.

22. The system for determining a call context according to claim 16, further comprising:
means for inferring a location of said at least one party to said call from said at least one scheduled event.

23. The system for determining a call context according to claim 22, wherein said location is at least one of a past location, a current location, and a future location.

24. The system for determining a call context according to claim 16, further comprising:
means for inferring a time said at least one party is available to communicate during said call from said at least one scheduled event.

25. The system for determining a call context according to claim 16, further comprising:
means for inferring an environment of said at least one party to said call from said at least one scheduled event.

26. The system for determining a call context according to claim 25, wherein said environment comprises a type of scheduled event, attendees of said at least one scheduled event, a subject of said at least one schedule event, and a background of said scheduled event.

27. The system for determining a call context according to claim 16, further comprising:
means for inferring at least one party in communication with at least one other participant at said at least one scheduled event.

28. The system for determining a call context according to claim 16, further comprising:
means for filtering said call context according to preferences of said at least one party; and
means for transferring said filtered call context to a requesting switching system for distribution.

29. The system for determining a call context according to claim 16, further comprising:
means for inviting at least one party to said call to join said scheduled event.

30. A computer program product for determining a call context, comprising:
a recording medium;
means, recorded on said recording medium, for enabling receipt of a context request for a call at said context inference server;
means, recorded on said recording medium, for accessing a schedule of at least one party to said call; and
means, recorded on said recording medium, for designating a context for said call indicating at least one scheduled event from said schedule relevant to said call.

31. The computer program product for determining a call context according to claim 30, further comprising:
means, recorded on said recording medium, for authenticating an identity of said at least one party to said call; and
means, recorded on said recording medium, for accessing said schedule of said at least one party to said call according to said authenticated identity of said at least one party.

32. The computer program product for determining a call context according to claim 30, further comprising:
means, recorded on said recording medium, for accessing said schedule from at least one data storage location within a trusted telephone network processing said call.

33. The computer program product for determining a call context according to claim 30, further comprising:
means, recorded on said recording medium, for accessing said schedule from at least one data storage location accessible via a network outside a trusted telephone network processing said call.

34. The computer program product for determining a call context according to claim 30, further comprising:
means, recorded on said recording medium, for accessing said schedule from a device utilized to place said call.

35. The computer program product for determining a call context according to claim 30, further comprising:
means, recorded on said recording medium, for accessing said schedule from a device utilized to answer said call.

36. The computer program product for determining a call context according to claim 30, further comprising:
means, recorded on said recording medium, for inferring a location of said at least one party to said call from said at least one scheduled event.

37. The computer program product for determining a call context according to claim 30, further comprising:
means, recorded on said recording medium, for inferring a time said at least one party is available to communicate during said call from said at least one scheduled event.

38. The computer program product for determining a call context according to claim 30, further comprising:
means, recorded on said recording medium, for inferring an environment of said at least one party to said call from said at least one scheduled event.

39. The computer program product for determining a call context according to claim 30, further comprising:
means, recorded on said recording medium, for inferring at least one party in communication with at least one other participant at said at least one scheduled event.

40. The computer program product for determining a call context according to claim 30, further comprising:
means, recorded on said recording medium, for filtering said call context according to preferences of said at least one party; and
means, recorded on said recording medium, for transferring said filtered call context to a requesting switching computer program product for distribution.

41. The computer program product for determining a call context according to claim 30, further comprising:
means, recorded on said recording medium, for inviting at least one party to said call to join said scheduled event.

42. A method for processing a call, comprising:
detecting a call request for a call within a trusted telephone network; and
requesting a context for said call, wherein said context indicates at least one scheduled event of at least one party to said call, wherein said at least one scheduled event is relevant to said call.

43. The method for processing a call according to claim 42, further comprising:
distributing said context for said call to a second party to said call, such that said second party is informed of said at least one scheduled event.

44. The method for processing a call according to claim 42, wherein requesting said context for said call further comprises:
initiating a context inference service at an intelligent peripheral within said trusted telephone network.

45. The method for processing a call according to claim 42, wherein requesting said context for said call further comprises:
initiating a secure channel to a telco application server accessible via a network outside said trusted telephone network; and
requesting initiation of a context inference service at said telco application server for determining said context for said call.

46. A system for processing a call, comprising:
a trusted telephone network;
means for detecting a call request for a call within said trusted telephone network; and
means requesting a context for said call, wherein said context indicates at least one relevant scheduled event of at least one party to said call.

47. The method for processing a call according to claim 46, further comprising:
means for distributing said context for said call to a second party to said call, such that said second party is informed of said at least one scheduled event.

48. The method for processing a call according to claim 46, wherein said means for requesting said context for said call further comprises:
means for initiating a context inference service at an intelligent peripheral within said trusted telephone network.

49. The method for processing a call according to claim 46, wherein requesting said context for said call further comprises:
means for initiating a secure channel to a telco application server accessible via a network outside said trusted telephone network; and
means for requesting initiation of a context inference service at said telco application server for determining said context for said call.

50. A system for processing a call, comprising:
a trusted telephone network;
means for detecting a call request for a call within said trusted telephone network; and
means for requesting a context for said call, wherein said context indicates at least one relevant scheduled event of at least one party to said call.

51. The system for processing a call according to claim 50, further comprising:
means for distributing said context for said call to a second party to said call, such that said second party is informed of said at least one relevant scheduled event.

52. The system for processing a call according to claim 50, wherein said means for requesting said context for said call further comprises:
means for initiating a context inference service at an intelligent peripheral within said trusted telephone network.

53. The system for processing a call according to claim 50, wherein said means for requesting said context for said call further comprises:
means for initiating a secure channel to a telco application server accessible via a network outside said trusted telephone network; and
means for requesting initiation of a context inference service at said telco application server for determining said context for said call.

54. A computer program product for processing a call, comprising:
a recording medium;
means, recorded on said recording medium, for detecting a call request for a call; and
means, recorded on said recording medium, for requesting a context for said call, wherein said context indicates at least one relevant scheduled event of at least one party to said call.

55. The computer program product for processing a call according to claim 54, further comprising:
means, recorded on said recording medium, for distributing said context for said call to a second party to said call.

56. A method for controlling a telephony device, comprising:
detecting a call context for a particular call at a telephony device utilized to participate in said call, wherein said call context indicates at least one scheduled event relevant to said call; and
controlling output of said call context from at least one output interface of said telephony device.

57. The method for controlling a telephony device according to claim 56, wherein said at least one output interface comprises a graphical user interface.

58. The method for controlling a telephony device according to claim 56, wherein said at least one output interface comprises an audible output interface.

59. The method for controlling a telephony device according to claim 56, wherein controlling output comprises filtering said call context according to output capabilities of said telephony device.

60. A method for controlling context from a telephony device, comprising:
detecting a current scheduled event selection for a party at a telephony device; and
responsive to a call initiated at said telephony device, transferring said current scheduled event selection as context to said call.

61. The method for controlling context according to claim 60, wherein detecting a current scheduled event selection further comprises:
detecting said current scheduled event selection designated from among a plurality of scheduled events.

62. The method for controlling context according to claim 60, wherein detecting a current scheduled event selection further comprises:
detecting said current scheduled event selected designated from a plurality of predefined types of events.

63. The method for controlling context according to claim 60, further comprising:
receiving a request to initiate placement of said call from said telephony device.

64. The method for controlling context according to claim 60, further comprising:
receiving a request to initiate receipt of said call at said telephony device.

65. The method for controlling context according to claim 60, further comprising:
filtering said current scheduled event according to filtering preferences selected by said party at said telephony device.
